(19) United States
(12) Patent Application Publication
(10) Pub. No.: US 2003/0055677 A1
(43) Pub. Date: Mar. 20, 2003

(54) Utility monitoring and management system

(75) Inventors: Keith R. Brown, Oklahoma City, OK (US); Gregory Tillman, Oklahoma City, OK (US); Timothy Huneycutt, Edmond, OK (US)

Correspondence Address: Martin G. Ozinga, Phillips McFall McCaffrey McVay & Murrah, P.C., One Leadership Square, 12th Floor, 211 N. Robinson Ave., Oklahoma City, OK, 73102, US

(73) Assignee: AUTOMATED ENERGY, INC.

(21) Appl. No.: 10/243,181

(22) Filed: Sep. 12, 2002

Related U.S. Application Data
(60) Provisional application No. 60/318,869, filed on Sep. 14, 2001.

(51) Int. Cl. G06F 17/60

(52) U.S. Cl. 705/1; 705/412

(57) ABSTRACT

An Internet-based utility management system that presents estimated utility prices, usage terms, and a predicted load profile to a customer. The estimated utility prices include predicted prices of a utility during certain future periods of time. The usage terms include a utility usage threshold for each certain future period of time below which the estimated price applies. The predicted load profile includes predicted utility usage of the customer for each certain future period of time and presented such that any variation between the usage terms and the predicted load profile is readily apparent.

This application claims priority to U.S. Provisional Application No. 60/318,869 filed Sep. 14, 2001, which is incorporated by reference in its entirety.

### TECHNICAL FIELD

This invention relates to monitoring and managing a utility, particularly an energy utility. More in particular, the invention is an Internet-based utility management system that presents estimated utility prices, usage terms, and a predicted load profile to a customer where the estimated utility prices may include predicted prices of a utility during certain future periods of time, the usage terms may include a utility usage threshold for each certain future period of time below which the estimated price applies, and the predicted load profile may include predicted utility usage of the customer for each certain future period of time and is presented such that any variation between the usage terms and the predicted load profile is readily apparent.

### BACKGROUND

In the utility industry, data acquisition and analysis systems are used to collect information about a customer's utility usage by customers. Data about utility usage can be analyzed to determine a utility customer's pattern of use over time. This pattern is known as a “load profile.” Load profiles may be created from utility consumption data for different time periods, such as, for example, a day, a week, or a year. Demand for electricity, water, gas, and other utilities is generally greatest during daylight and business hours, but may also depend on other factors, such as weather conditions or a customer's production schedule. To operate at a constant output rate, a utility supplier may charge different prices for utility consumption during peak and low demand periods. For example, utility suppliers often price electricity higher during daylight hours when businesses are operating, and lower during nighttime hours.

In general, utility suppliers (e.g., power companies) charge commercial customers for reserving capacity and may allocate resources and charge a price to a customer based on the customer's peak demand. For example, a utility supplier may reserve capacity for a customer for an upcoming time interval (e.g., 12 months) based on the peak demand level for a past time interval (e.g., 12 months). If the customer exceeds the capacity level set by the utility supplier (i.e., the peak demand level) the utility supplier resets the capacity level to the new, higher peak demand, sets a new price, and often charges a penalty.

Typically, once the customer establishes a peak, the utility supplier reserves capacity and the customer must pay for the utility whether it is consumed or not. The utility supplier operates on the assumption that the customer at any time during the upcoming time interval may require the utility at the peak demand level and, therefore, reserves the capacity for the customer. The price charged by the utility supplier reflects reserved capacity at the peak demand level. Accordingly, it is in a customer's interest to avoid random spikes (i.e., short-term high utility use) in the customer's load profile because even a one-time overuse of a utility may result in extended overpaying for a utility that is never consumed.

Energy suppliers typically employ conservative pricing tactics, such as the one discussed above, in order to reduce the risks associated with price fluctuations. Even though energy suppliers generally offer energy at a fixed rate to customers, the spot price of energy (i.e., the price of energy at a given point in time) is constantly fluctuating. Fluctuations in energy price may depend on factors such as gas prices, coal prices, or other costs associated with the fuel used to create electric energy. To allow for these price fluctuations, energy suppliers build in margins into the offered price of energy to keep the offered price above the production cost. This practice, in effect, passes the risk of price fluctuations onto the customers. For example, the cost to an energy supplier associated with production (e.g., generating, transmitting, and distributing energy) may be $0.02/kWh one day and $0.12/kWh the next. To allow for price variation and to avoid much of the risk, the energy supplier may charge its customers $0.10/kWh every day to ensure a profit.

In theory, deregulation should result in an efficient market for energy. In a deregulated market, energy suppliers will face increased competition and should adapt their pricing strategies to attract and maintain customers. Because customers will have more energy suppliers to choose from, energy suppliers will be motivated to offer pricing plans that accurately reflect a customer's actual usage. However, until customers have access to the same information that energy suppliers do, energy suppliers will always have more knowledge and more freedom to set energy prices in their favor. Even though deregulation means that energy suppliers will assume additional risks (e.g., no guaranteed rate of return), customers are not able to evaluate whether the price offered by an energy supplier is fair or inflated. This unequal access to information allows energy suppliers to pass most risks on to customers.

### SUMMARY

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

In one general aspect, an Internet-based utility management system presents estimated utility prices, usage terms, and a predicted load profile to a customer. The estimated utility prices include predicted prices of a utility during certain future periods of time. The usage terms includes a utility usage threshold for each certain future period of time below which the estimated price applies. The predicted load profile includes predicted utility usage of the customer for each certain future period of time and is presented such that any variation between the usage terms and the predicted load profile is readily apparent.

Implementations may include one or more of the following features. For example, the estimated utility prices may include the predicted spot prices of a utility for each hour of an upcoming day. Presenting the usage terms may include determining and displaying a customer usage baseline illustrating the threshold limits below which standard estimated prices apply. Determining the customer usage baseline may include analyzing historical use data. The customer usage baseline can be tailored to the expected utility usage of the customer. Presenting the predicted load profile may include analyzing one or more previous actual load profiles of the customer.

Other implementations may include presenting predicted utility margins, presenting predicted incremental costs, evaluating future utility consumption, determining a utility management program, reaching an agreement as to utility price and usage terms, presenting allocated utility capacity, presenting actual utility consumption, presenting actual utility margins, presenting actual incremental costs, and/or completing a payment transaction.

The utility management system may present a user interface to customers. The user interface may be a Web page having charts, figures, graphs, text, images, audio, video and/or any other type of content. The utility management system also may analyze price data, cost data, weather data, and usage data may be analyzed. Data may be delivered by at least one of e-mail, facsimile, telephone, satellite transmission, the Web and/or the Internet.

These and other general aspects may be implemented by an apparatus and/or by a computer program stored on a computer readable medium. The computer readable medium may comprise a disk, a client device, a host device, and/or a propagated signal.

Other features and advantages will be apparent from the following description, including the drawings, and from the claims. These, together with other objects of the invention, along with the various features of novelty which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there is illustrated preferred embodiments of the invention.

### DESCRIPTION OF THE DRAWINGS

The invention will be better understood and objects other than those set forth above will become apparent when consideration is given to the following detailed description thereof. Such description makes reference to the annexed pictorial illustrations, graphs, drawings, and appendices wherein:

FIG. 1 is a schematic diagram of a data collection and analysis system.

FIGS. 2 and 3 are graphical user interfaces that may be displayed by the data collection and analysis system of FIG. 1.

FIG. 4 is a flow chart illustrating a method that may be implemented by the data collection and analysis system of FIG. 1.

FIGS. 5, 6A, and 6B are graphical user interfaces that may be displayed by the data collection and analysis system of FIG. 1.

FIG. 7 is a schematic diagram of a computer system implemented by the data collection and analysis system of FIG. 1.

Like reference symbols in the various drawings indicate like elements.

### DETAILED DESCRIPTION

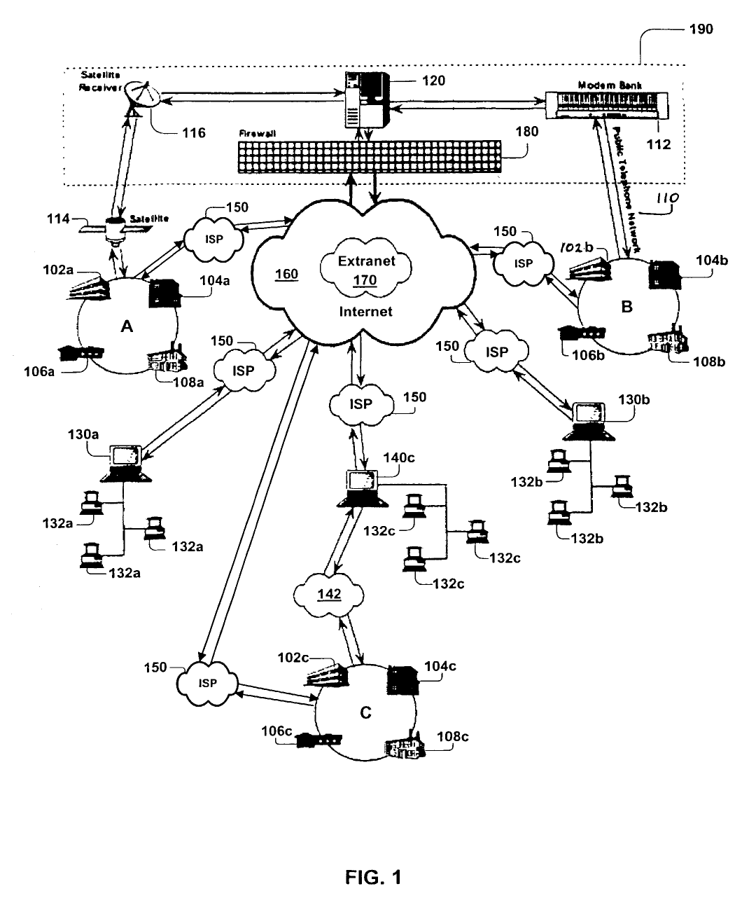

Referring to FIG. 1, a utility data collection and analysis system 100 includes clients in communication with a host 190. The data collection and analysis system 100 is capable of collecting and analyzing utility consumption data and may be configured for customer-specific applications. For example, the data collection and analysis system 100 may be implemented by a utility company that collects and analyzes data about customers' utility usage from remote terminal units (“RTUs”) located at each customer's site. In another implementation, the data collection and analysis system 100 includes or is part of an intermediary (e.g., host system) that serves several different organizations by collecting and analyzing utility consumption data and then allowing the individual organizations to access the raw and processed data over a wide area network (e.g., Internet and/or World Wide Web).

Different utility suppliers may serve different customers (i.e., utility customers). For example, utility A may supply a utility to customers 102a, 104a, 106a, and 108a, and utility B may supply a utility to customers 102b, 104b, 106b, and 108b . Different utilities also may include client computers (e.g., 130a, 130b, 140c) for transmitting data to and from the host 190 through an Internet 160. An individual utility also may include software applications 132a, 132b, 132c on client computers 130a, 130b, 130c for processing data pertaining to the individual utility or to the customers of the utility.

Clients, including utility suppliers (e.g., utility A, utility B, or utility C) and utility customers (e.g., 102a, 104a, 106a, 108a), may access host 190. The host 190 may be protected by a firewall 180, and may be accessed through an Internet-enabled extranet 170 provided by the host 190. A user may be given selective access to data stored on host 190, such that the confidentiality of other users' data stored on host 190 is maintained. For example, utility A may be given selective access only to data concerning customers of utility A (e.g., 102a, 104a, 106a, and 108a), while utility B is given access only to data concerning customers of utility B (e.g., 102b, 104b, 106b, and 108b). Individual customers of a utility (e.g., 102a, 104a, 106a, 108a, 102b, 104b, 106b, 108b, 102c, 104c, 106c, and 108c) may be given selective access only to their own data, but not to data of other customers of the same utility or to data of the customers of other utilities. Selected data may be downloaded to the client computer 130a of a user from host 190 through an Internet Service Provider (“ISP”) 150.

In general, the host 190 is configured to perform data acquisition and analysis. In one implementation, the host 190 is an Internet-enabled centralized system that receives utility usage data from meters and RTUs. Customers, utility suppliers, and/or other users of the service then may access the host 190 through the Internet 160 to display and interpret the relevant utility consumption data.

The host 190 may include software and/or hardware for receiving information from the clients. For example, the host 190 may include a modem bank 112 for receiving information transmitted over telephone or cable lines 110 and/or a satellite receiver 116 for receiving information over a wireless transmission link. The host 190 may include one or more server computers 120 running software for receiving data from modem bank 112 or satellite receiver 116, for storing data, and for processing the data. The software may include Internet-enabled analysis software accessible over a wireless Internet connection.

The host 190 may upload a variety of data types from clients (e.g., suppliers and customers). Each client may be associated with one or more customers. Examples of customers include an office building such as customer 102a, a production facility such as customer 104a, a residence such as customer 106a, or an apartment complex such as customer 108a. The customer may have an RTU configured to monitor and collect utility consumption data from the customer's location. The RTU may upload data from the customer's site directly to the host 190 through wired and/or wireless communications links. For example, the RTU may send data over the Internet 160 through the ISP 150 to the host 190. The RTU also may indirectly upload data from a customer to host 190 by sending the data over a data transmission link 142 to the utility supplier's host computer 140, data which then stores the data and forwards the data to the host 190.

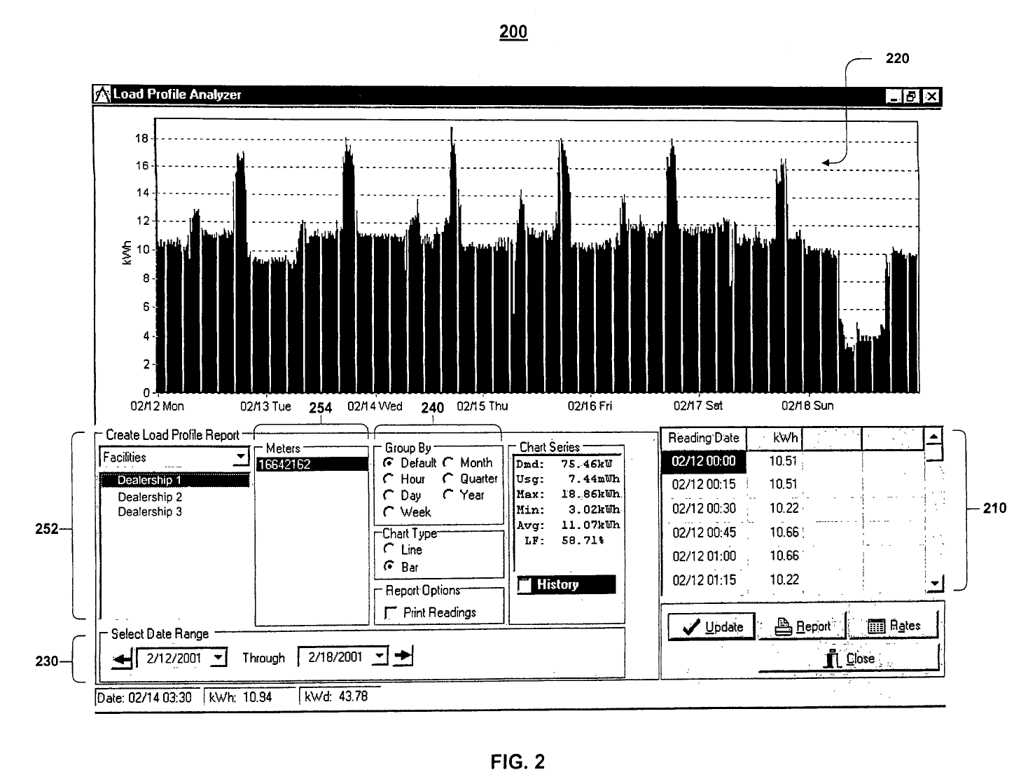

Referring to FIG. 2, a user interface (“UI”) 200 is displayed by a software application provided by host 190. In one implementation, the UI 200 may be implemented by an Internet-enabled framework, as described in U.S. application Ser. No. 09/828,170, which is incorporated by reference in its entirety. The software application is accessible through extranet 170 (FIG. 1) and is capable of storing energy usage data retrieved from one or more RTUs.

The UI 200 displays utility usage data including a time series 210 of utility units consumed by a RTU at regular intervals. The time series 210 is displayed graphically as a load profile 220. Different time periods of the time series 210 may be selected for graphical display by entering beginning and ending times for the display through a date range selection box 230. The format and density of points in the time series 210 plot may be chosen from several predetermined formats 240. Load profiles 220 may be created from data recorded by one or more RTUs. For example, load profiles 220 may be created for different facilities 252, or for the data from different meters 254 at a facility according to the user's choice.

The load profile 220 displayed in FIG. 2 corresponds to utility consumption (e.g., electric energy consumption) at a particular facility 252 (e.g., Dealership 1). According to the load profile 220, the peak consumption for Dealership 1 occurs approximately between the hours of 4:00 p.m. and 8:00 p.m., Monday through Saturday. Using this information, Dealership 1 may be able to negotiate with a utility supplier for a lower monthly rate for future energy because the periods of peak consumption do not coincide with normal periods of high demand (e.g., between 9:00 a.m. and 3:00 p.m., Monday through Friday). A utility supplier also may view the load profile 220 and prospectively offer a competitive rate to Dealership 1 based on its usage pattern. Without the availability of the information contained in the time series data 210 and the load profile 220, Dealership 1 typically would have to purchase energy from a supplier based on total energy consumption for a month or based on peak energy consumption during a period of time, and could not benefit from the fact that its peak consumption occurs during low demand hours.

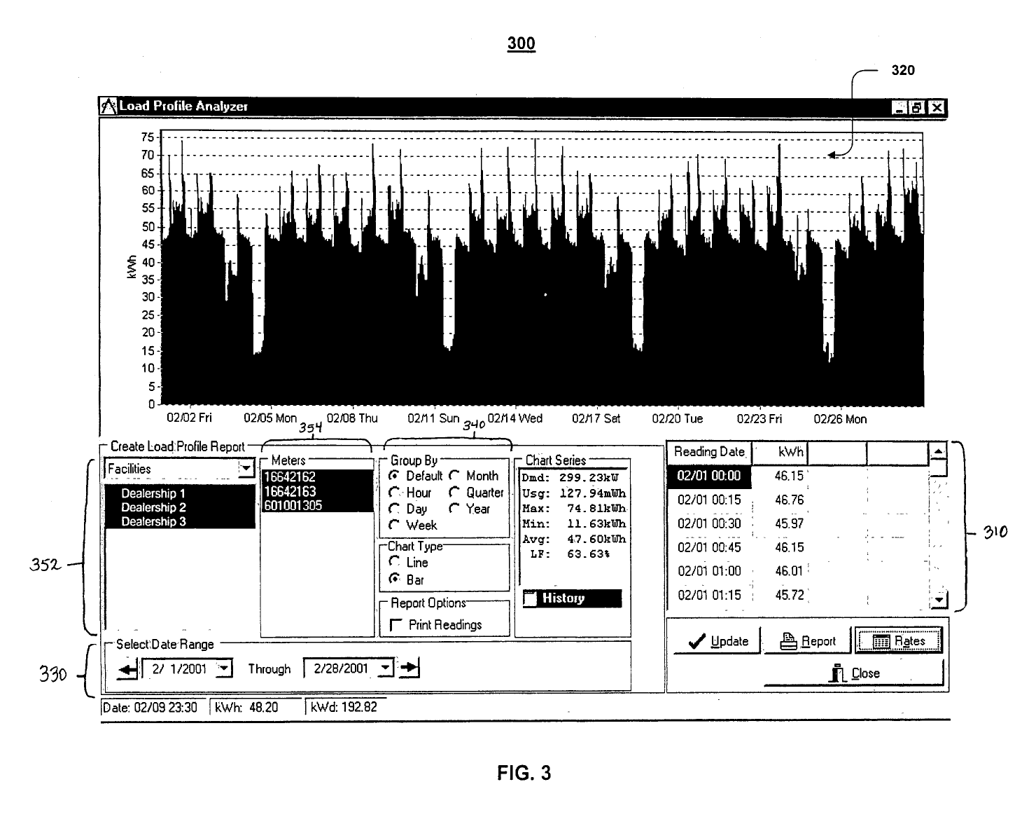

Referring to FIG. 3, a UI 300 displays an aggregate load profile 320 for energy consumption of different facilities 352 (Dealership 1, Dealership 2, and Dealership 3) during the month of February 2001. Aggregate load profiles 320 may be created from data derived from multiple facilities (e.g., RTUs). For example, load profiles 320 tracking the utility consumption of a group of a customer's facilities, of a group of customers, of a geographic region, or of a group of sites served by a particular utility plant may be created and displayed. Having aggregate information about a customer's utility consumption on a fine timescale (measured every hour, or every few minutes) is useful both to the utility supplier and to the utility customer, as it permits them to negotiate a price for the utility in an efficient market. Load profiles 320 for several different facilities 352 may be analyzed, to permit a customer to “package” facilities together in order to negotiate a package rate for the group of facilities. If some facilities 352 use energy mostly at night and others generally consume energy during the day, their collective consumption may not vary greatly, which may be attractive for a utility supplier that wants to match a relatively constant supply to relatively constant demand. A utility supplier may offer price incentives to a customer who purchases the utility for the entire group, since the consumption of a large group generally fluctuates less than the consumption of an individual. Additionally, the utility supplier may offer incentives to encourage a group to use energy at a steady rate, with relatively low fluctuations.

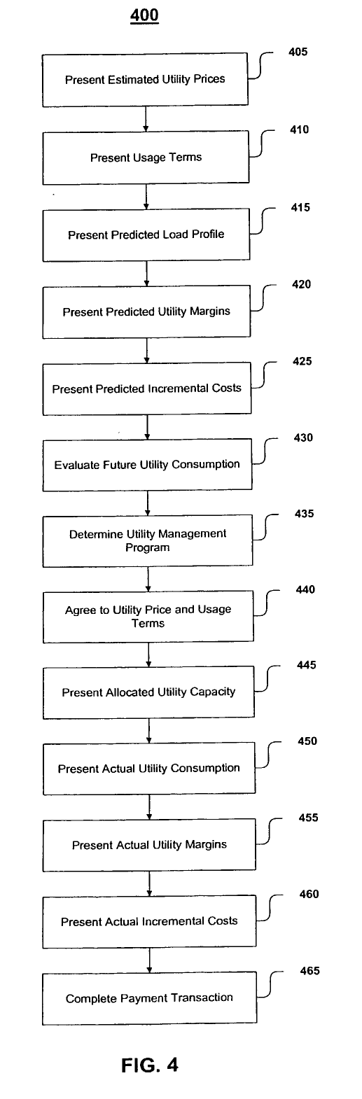

Referring to FIG. 4, a utility data collection and analysis system 100 (FIG. 1) operates according to a procedure 400. The procedure 400 may be implemented by any suitable type of hardware (e.g., device, computer, computer system, equipment, component), software (e.g., program, application, instructions, code), storage medium (e.g., disk, external memory, internal memory, propagated signal), or combination thereof.

The procedure 400 generally involves estimating a customer's utility usage and offering a pricing plan to the customer based on real-time utility prices. The pricing plan may include a forecast of short-term utility prices that accurately reflects the cost of providing the utility to the customers. Forecasting short-term utility prices will reduce a utility supplier's risk associated with drastic price fluctuations. By presenting an individualized pricing plan to a customer, the utility supplier gives the customer the option to accept the costs and/or penalties of usage (i.e., incremental costs) or to shift load to off-peak hours in order to lower costs. The utility customers thus have access to lower prices rather than a single average price. By choosing when to accept and/or avoid higher prices, utility customers are able to reduce their average energy costs. At the same time, the utility suppliers are able to reduce risk, increase loyalty from existing customers, and increase marketability to prospective customers.

Initially, estimated utility prices are presented (step 405). In general, the estimated utility prices 405 include the predicted prices of a utility during certain periods of time. For example, the estimated utility prices may include the predicted spot prices of a utility for each hour of the next day. The estimated utility prices 405 may be presented as twenty-four separate, but not necessarily different, representations of each hourly spot price of the utility during the next day. In a deregulated energy market, the price of energy varies on such a short-term timescale.

Estimating utility prices 405 may include analyzing historical and/or predicted pricing data, cost data, weather data, usage data, or other supply-and-demand related data. For example, utility suppliers may analyze utility consumption data in order to anticipate fluctuating demand so that resources can be allocated to meet the demand and to set demand-dependent rates. Typically, if a utility supplier predicts that the demand for a utility will be high during a time period when the supply of the utility is low, the utility supplier will set a high price and/or impose severe penalties to customers that exceed an allotted amount of the utility. In this way, utility suppliers are able to predict future demand, determine a price, and create an efficient market for the utility.

The host and/or the utility supplier may calculate the estimated utility prices 405 using price calculation software, for example. If calculated by the utility supplier, the estimated utility prices 405 may be transmitted to the host for posting. The estimated utility prices 405 and other information transmitted to the host may be transmitted by any suitable delivery method including, but not limited to, delivery by e-mail, facsimile, telephone, satellite transmission, the Web and/or the Internet.

In one implementation, the host presents the estimated utility prices 405 to customers that access the host through the Internet. A customer may be required to enter a user identification and password to access the host. The host may present the estimated utility prices 405 to the customer as a UI (e.g., Web page). This and other UI's presented by the host may have charts, figures, graphs, text, images, audio, video, and/or any other type of content. The UI may graphically display the estimated utility prices 405 in one-hour (or other time period) increments representing the predicted price ($/kWh) of the utility for each hour of the next day.

Next, usage terms are presented (step 410). In general, the usage terms 410 include limitations and/or constraints on the estimated utility prices. For example, the usage terms 410 may represent a utility usage threshold below which the estimated utility price 405 applies. The usage terms 410 may be presented with the estimated utility prices 405 to show applicable constraints for each time period (e.g., each hour).

Presenting the usage terms 410 may include determining and displaying a customer usage baseline (“CUB”). A CUB may be displayed as an hourly (or other time period) usage profile illustrating the threshold limits below which standard rates apply. Determining a CUB may include analyzing historical use data or any other representative data. The CUB may be individualized for each customer and tailored to the expected utility usage of the customer. In general, the threshold limit is set such that a customer's normal usage does not trigger higher prices and penalties. However, in some cases, the CUB may be used as an incentive for a customer to decrease normal usage in order to take advantage of a special low rate. In either case, the CUB conveys the usage terms 410 in a clear manner that protects the revenues for utility suppliers and protects customers from unexpected high prices.

The host and/or the utility supplier may calculate usage terms 410 based on one or more of historical and/or predicted pricing data, cost data, weather data, usage data, or other supply-and-demand related data. If calculated by the utility supplier, the usage terms 410 may be transmitted to the host for posting.

In one implementation, the host posts and releases the usage terms 410 to customers that access the host through the Internet. The host may present the usage terms 410 to the customer as a UI (e.g., Web page). The UI may graphically display the usage terms 410 with the estimated utility prices 405 in one-hour (or other time period) increments representing utility usage thresholds (kWh) below which the estimated utility price 405 applies. To illustrate, between the hours of 9:00 a.m. and 10:00 a.m., an estimated price of $0.05/kWh may be applicable only if the customer uses less than 1,600 kWh. Otherwise, a higher price and/or penalties may be applied.

Then, a predicted load profile is presented (step 415). In general, the predicted load profile 415 includes the utility usage of a customer for a certain time period. For example, the predicted load profile 415 may represent the predicted utility usage for a customer at each hour (or other time interval) for the next day. The predicted load profile 415 may be presented with the estimated utility prices 405 and/or the usage terms 410 to illustrate the applicability of certain estimated utility prices to certain amounts of predicted utility consumption as well as to illustrate any variation between the usage terms 410 and the predicted load profile 415.

Predicting a load profile 415 representing future utility consumption may include analyzing one or more of a particular customer's previous load profiles. Different load profiles corresponding to utility usage at various times may be analyzed to determine historical trends or patterns in utility usage. For example, previous load profiles may be analyzed to determine whether certain periods of time or certain other factors are determinative of utility usage.

The host and/or the utility supplier may create the predicted load profile 415 using proprietary forecasting software, for example. The predicted load profile 415 may be based on one or more of historical and/or predicted pricing data, cost data, weather data, usage data, or other supply-and-demand related data. If created by the utility supplier, the predicted load profile 415 may be transmitted to the host for posting.

In one implementation, the host posts and releases the predicted load profile 415 to customers that access the host through the Internet. The host may present the predicted load profile 415 to the customer as a UI (e.g., Web page). The UI may display the predicted load profile 415 with the estimated utility prices 405 and/or the usage terms 410 in one-hour (or other time period) increments representing the predicted utility usage (kWh) for the next day.

Next, predicted utility margins are presented (step 420). In general, the predicted utility margins 420 include the deviation of the predicted load profile 415 from the usage terms 410 for a certain time period. For example, the predicted utility margins 420 may represent the difference between the predicted utility usage and the usage terms 410 (e.g., CUB) at each hour (or other time interval) for the next day. The predicted utility margins 420 may be presented with the estimated utility prices 405, the usage terms 410, and/or the predicted load profile 415 to illustrate the incremental and/or total variation between the usage terms 410 and the predicted load profile 415 for each hour (or other time period) of the next day.

Determining the predicted utility margins 420 may include calculating the variation of the CUB from the predicted load profile 415. The variation of the CUB and the predicted load profile 415 may be calculated by taking the difference between predicted utility consumption and the CUB threshold limit for each time period (e.g., each hour).

The host and/or the utility supplier may calculate the predicted utility margins 420. If calculated by the utility supplier, the predicted utility margins 420 may be transmitted to the host for posting.

In one implementation, the host posts and releases the predicted utility margins 420 to customers that access the host through the Internet. The host may present the predicted utility margins 420 to the customer as a UI (e.g., Web page). The UI may display the predicted utility margins 420 with the estimated utility prices 405, the usage terms 410, and/or the predicted load profile 415 in one-hour (or other time period) increments representing the deviation (kWh) of the predicted load profile 415 from the usage terms 410 during each hour (or other time period) of the next day.

Next, predicted incremental costs are presented (step 425). In general, the predicted incremental costs 425 include the costs associated with the deviation of the predicted load profile 415 from the usage terms 410 for a certain time period. For example, the predicted incremental costs 425 may represent specific monetary values associated with the deviation of the predicted load profile 415 from the usage terms 410 during each hour (or other time period) of the next day. The predicted incremental costs 425 may be displayed with the estimated utility prices 405, the usage terms 410, the predicted load profile 415, and/or the predicted utility margins 420 for reference.

Determining the predicted incremental costs 425 may include associating a monetary value with the predicted utility margins 420. The associated monetary value may include the estimated utility prices 405 and/or a fixed or graded penalty for exceeding the usage terms 410 (e.g., CUB). The predicted incremental costs 425 may be calculated by multiplying the associated monetary values by the predicted utility margins 420 for each hour (or other time period). Total incremental costs may be calculated for a specified day, month, or year.

The host and/or the utility supplier may calculate the predicted incremental costs 425. If calculated by the utility supplier, the predicted incremental costs 425 may be transmitted to the host for posting.

In one implementation, the host posts and releases the predicted incremental costs 425 to customers that access the host through the Internet. The host may present the predicted incremental costs 425 to the customer as a UI (e.g., Web page). The UI may display the predicted incremental costs 425 with the estimated utility prices 405, the usage terms 410, the predicted load profile 415, and/or the predicted utility margins 420 in one-hour (or other time period) increments representing the cost ($) associated with the predicted utility margins 420 (kWh) during each hour (or other time period) of the next day.

Next, future utility consumption is evaluated (step 430). In general, future utility consumption 430 includes an estimated amount of a utility required for a certain period of time. For example, future utility consumption 430 may represent the estimated amount of a utility required to operate necessary facilities and/or equipment of a customer for each hour (or other time period) of the next day.

Evaluating future utility consumption 430 may include confirming that future utility consumption 430 is consistent with the presented predicted load profile 415, for example, by analyzing the data and/or underlying assumptions used to create the predicted load profile 415 and comparing them to the forecasted data for the next day.

The customer and/or host may evaluate future utility consumption 430 in light of the estimated utility price 405, usage terms 410 (e.g., CUB), predicted load profile 415, predicted utility margin 420, and/or predicted incremental cost 425. For example, when presented with such information, the customer and/or host can evaluate whether the costs associated with certain utility-consuming activities planned for the next day are worth undertaking. In some cases, it may be cost effective for the customer to curtail certain activities and/or offload certain facilities to avoid high prices and penalties, especially during peak hours.

In one implementation, the host prompts the customer to confirm that the presented predicted load profile 415 is consistent with future utility consumption 430 for the next day. This allows the customer to take into account any special circumstances of the predicted load profile 415 and/or of the next day, such as, for example, unusually high temperatures or exceptionally high production requirements. Confirming that the predicted load profile 415 is consistent may be accomplished by viewing and interacting with a UI (e.g., web page) displaying the presented predicted load profile 415.

Next, a utility management program is determined (step 435). In general, a utility management program 435 includes actions for reducing energy consumption and/or minimizing incremental cost. The utility management program 430 may be tailored to the specific facilities, equipment, and/or requirements of the customer. The utility management program 430 may include, for example, offloading the use of certain equipment and/or facilities during peak hours. The utility management program 430 also may include sufficiently reducing utility consumption by a certain amount (i.e., percentage) so as to comply with the usage terms 410 or to achieve a reduced peak demand level.

The utility management program 435 may include specific suggested actions to take in order to comply with the usage terms 410 or to achieve the reduced peak demand level. For example, the utility management program 435 may suggest shutting down specified energy-consuming devices (e.g., generators, elevators, lights, air conditioners) in a particular facility for a certain period of time. The utility management program 435 may suggest an enterprise-wide approach involving several different combinations of devices and/or facilities. The utility management program 435 also may include user preferences for customizing the suggested action to minimize total down time, minimize down time during normal business hours, minimize the total number of idle devices, minimize the number of idle devices during normal business hours, and/or otherwise minimize customer inconvenience.

Determining a utility management program 435 may involve having the customer select one of several proposed utility management programs or elements from one or more proposed utility management programs. In general, selection of a proposed utility management program (or elements of a utility management program) includes determining avoidable utility consumption and/or deciding upon the least burdensome course of action that will achieve a certain reduction. A utility management program 435 (or elements of a utility management program) may be assigned a particular level (e.g., Level 1, Level 2, Level 3) based on the severity of the action required to reduce consumption and/or the burden on the customer to achieve a certain reduction. For example, a Level 1 utility management program 435 may involve a subtle change in the operation of certain equipment, while a Level 3 utility management program 435 may involve drastically removing certain equipment and/or facilities from use.

In one implementation, the host proposes several utility management programs 435 for reducing utility consumption. The host may present a UI (e.g., Web page) including predicted load profiles 415 corresponding to each proposed utility management program so that a customer can readily compare the benefits and burdens of various proposed utility management programs. The customer may determine and/or select the most appropriate utility management program 435 based on avoidable utility consumption and/or the burden to achieve a certain reduction. The most appropriate utility management profile may correspond to the predicted load profile 415 that achieves compliance with usage terms 410 while minimizing customer inconvenience, for example, by offloading only nonessential facilities and/or equipment.

Next, an agreement is reached as to utility price and usage terms (step 440). In general, agreement 440 is reached between the customer and the utility supplier. Typically, the agreement 440 involves purchasing a utility in compliance with the usage terms 410 (e.g., utility usage below the CUB) at a standard utility price and purchasing a utility in violation of the usage terms (e.g., utility usage in excess of the CUB) at a penalized utility price. Agreeing to the estimated utility prices 405 and usage terms 410 may include locking-in the presented estimated utility prices 405 and usage terms 410 for the next day.

Reaching an agreement 440 as to estimated utility prices 405 and usage terms 410 also may include negotiating lower standard prices in exchange for stricter usage terms (e.g., a reduced CUB). Higher penalties for violating the usage terms 410 (e.g., utility usage in excess of the CUB) also may accompany lower standard prices. For example, prior to reaching the agreement 440, the customer may inform the host and/or the utility supplier of a planned utility management program and may request lower prices. By agreeing to reduce utility usage according to the planned utility management program 435, the customer may be able to negotiate a lower standard price for the utility. In general, this option will be available to a customer when the utility management program 435 reduces energy consumption to levels well within usage terms 410. This situation may be displayed graphically by showing the load profile associated with the energy management program falling below the CUB.

Reaching the agreement 440 as to estimated utility prices 405 and usage terms 410 also may include negotiating a rebate for unutilized capacity. The utility supplier and/or the host may implement a rebate program. As discussed above, a utility supplier (e.g., power company) may charge a customer for reserving capacity based on the customer's past peak demand for certain time interval (e.g., past twelve months). In this type of pricing arrangement, the utility supplier establishes a baseline capacity (e.g., 1800 kWh), charges the customer for the right to use the capacity even if the customer does not use the total amount, and charges the customer a penalty if the baseline capacity is exceeded. In a deregulated market, however, it may not be practical for a utility supplier to require that customers pay for unutilized capacity, particularly if the customers have access to real-time utility consumption data. Indeed, if customers are able to accurately monitor actual usage, competition may dictate that utility suppliers charge customers only for the amount of utility that is consumed.

In one implementation, the utility supplier maintains a customer account and agrees to refund payment and/or credit the account when a customer prepays for a utility that is not consumed. In another implementation, the host maintains a customer account that is credited according to unutilized capacity. The rebate situation may be displayed graphically by showing the load profile associated with the actual consumption falling below the CUB.

After the agreement 440 has been reached, allocated utility capacity is presented (step 445). In general, allocated utility capacity 445 includes permitted utility consumption during a certain period of time. For example, allocated utility capacity 445 may represent the utility capacity 445 (kWh) allocated for consumption during the one-hour (or other time period) intervals for each hour of the next day. The allocated utility capacity 445 may correspond to and be displayed with locked-in estimated utility prices 405 and/or rebate prices. The allocated utility capacity 445 also may be displayed with the estimated utility prices 405, the usage terms 410, the predicted load profile 415, the predicted utility margins 420, the predicted incremental costs 425, and/or a planned utility management program 435 for reference.

In general, utility capacity 445 is allocated according to the agreement 440 (e.g., accepted usage terms 410). For example, a CUB corresponding to the accepted usage terms 410 may be segmented into time periods (e.g., months, days, weekdays, peak hours, hours), and the allocated utility capacity 445 associated with each time period may be distributed to a customer.

The host or the utility supplier may establish the allocated utility capacity 445. If established by the utility supplier, the allocated utility capacity 445 may be transmitted to the host for posting.

In one implementation, the host posts and releases the allocated utility capacity 445 to customers that access the host through the Internet. The host may present the allocated utility capacity 445 to the customer as a UI (e.g., Web page). The allocated utility capacity 445 may be displayed with the estimated utility prices 405, the usage terms 410, the predicted load profile 415, the predicted utility margins 420, and/or the predicted incremental costs 425 in one-hour (or other time period) increments representing the utility capacity 445 (kWh) allocated for consumption during each one-hour (or other time period) interval of the next day.

Next, actual utility consumption is presented (step 450). In general, the actual utility consumption 450 includes the actual amount of utility consumed in a certain period of time. For example, actual utility consumption 450 may be displayed as an actual load profile representing the actual amount of utility consumed during each hour of a particular day. The actual utility consumption 450 may be displayed with the estimated utility prices 405, the usage terms 410, the predicted load profile 415, the predicted utility margins 420, the predicted incremental costs 425, and/or the allocated utility capacity 445 for reference.

Typically, the presentation of the actual utility consumption 450 occurs substantially in real time or with relatively short delays between the time of utility consumption and the time of presentation. Determining the actual utility consumption 450 may include receiving utility consumption data from the customer. The customer may include facilities and/or equipment including RTUs capable of collecting and transmitting utility consumption data substantially in real time as the utility is consumed.

The host and/or the utility supplier may calculate the actual utility consumption 450 using utility monitoring software, for example. If calculated by the utility supplier, the actual utility consumption 450 may be transmitted to the host for posting.

In one implementation, the host posts and releases the actual utility capacity 445 to customers that access the host through the Internet. The host may present the actual utility consumption 450 to customers as a UI (e.g., Web page). The actual utility consumption 450 may be displayed as an actual load profile with the estimated utility prices 405, the usage terms 410 (e.g., CUB), the predicted load profile 415, the predicted utility margins 420, the predicted incremental costs 425, and/or the allocated utility capacity 445 in one-hour (or other time period) increments representing the current level of utility consumption (kWh) during a certain one-hour (or other time period) interval of a particular day. For example, at 3:15 p.m., the actual utility consumption 450 may be displayed as an actual load profile indicating the current total amount of utility consumed as of 3:15 p.m. as well as the current total amount of utility consumed between 2:00 p.m. and 3:00 p.m.

Then, actual utility margins are presented (step 455). In general, the actual utility margins 455 include the deviation of the actual utility consumption 450 from the allocated utility capacity 445 for a certain period of time. For example, the actual utility margins 455 may represent the difference (kWh) between the actual utility consumption 450 and the allocated utility capacity 445 during each hour (or other time period) of the day. Daily or monthly utility margin totals may be calculated and presented. The actual utility margins 455 may be displayed with the estimated utility prices 405, the usage terms 410, the predicted load profile 415, the predicted utility margins 420, the predicted incremental costs 425, the allocated utility capacity 445, and/or the actual utility consumption 450 for reference.

Typically, the presentation of the actual utility margins 455 occurs substantially in real time or with relatively short delays between the time of actual utility consumption 450 and the time of presentation. Determining the actual utility margins 455 may include calculating a surplus and/or a deficit of allocated utility capacity 445 for a certain period of time. A surplus of utility capacity indicates that for a certain period of time the actual utility consumption 450 is below the allocated utility capacity 445. A deficit of utility capacity indicates that for a certain period of time the actual utility consumption 450 is exceeding the allocated utility capacity 445.

The host and/or the utility supplier may calculate the actual utility margins 455. If calculated by the utility supplier, the actual utility margins 455 may be transmitted to the host for posting.

In one implementation, the host posts and releases the actual utility margins 455 to customers that access the host through the Internet. The host may present the actual utility margins 455 to customers as a UI (e.g., Web page). For example, the actual utility margins 455 may be displayed with the estimated utility prices 405, the usage terms 410 (e.g., CUB), the predicted load profile 415, the predicted utility margins 420, the predicted incremental costs 425, allocated utility capacity 445, and/or the actual utility consumption 450 in one-hour (or other time period) increments representing the current deviation (kWh) of the actual utility consumption 450 from the allocated utility capacity 445 during a certain one-hour (or other time period) interval of a particular day. For example, at 3:15 p.m., the actual utility margins 455 may indicate the current total deviation of the actual utility consumption 450 from the allocated utility capacity 445 as of 3:15 p.m. as well as the deviation between the hours of 2:00 p.m. and 3:00 p.m.

Next, actual incremental costs are presented (step 460). In general, the actual incremental costs 460 include the costs associated with the deviation of the actual utility consumption 450 from the allocated utility capacity 445 for a certain time period. For example, the actual incremental costs 460 may represent specific monetary values associated with the deviation of the actual utility consumption 450 (e.g., actual load profile) from the allocated utility capacity 445 during each hour (or other time period) of a particular day. The actual incremental costs 460 may be displayed with the estimated utility prices 405, the usage terms 410, the predicted load profile 415, the predicted utility margins 420, the predicted incremental costs 425, the allocated utility capacity 445, the actual utility consumption 450, and/or the actual utility margins 455 for reference.

Typically, the presentation of the actual incremental costs 460 occurs substantially in real time or with relatively short delays between the time of actual utility consumption 450 and the time of presentation. Determining the actual incremental costs 460 may include associating a monetary value with the actual utility margins 455. The associated monetary value may include the locked-in estimated utility prices 405 and/or a fixed or graded penalty for exceeding the allocated utility capacity 445. The actual incremental costs 460 may be calculated by multiplying the associated monetary values by the actual utility margins 455 for each hour (or other time period). Total incremental costs may be calculated for a specified day, month, or year.

The host and/or the utility supplier may calculate the actual incremental costs 460. If calculated by the utility supplier, the actual incremental costs 460 may be transmitted to the host for posting.

In one implementation, the host posts and releases the actual incremental costs 460 to customers that access the host through the Internet. The host may present the actual incremental costs 460 to the customer as a UI (e.g., Web page). The UI may display the actual incremental costs 460 with the estimated utility prices 405, the usage terms 410, the predicted load profile 415, the predicted utility margins 420, the predicted incremental costs 425, the allocated utility capacity 445, the actual utility consumption 450, and/or the actual utility margins 455 in one-hour (or other time period) increments representing the actual cost ($) associated with the actual utility margins (kWh) during each hour (or other time period) of the next day. For example, at 3:15 p.m., the actual incremental costs 460 may indicate the current total costs incurred as of 3:15 p.m. as well as the costs incurred between the hours of 2:00 p.m. and 3:00 p.m.

Finally, a payment transaction is completed (step 465). In general, a payment transaction 465 includes a reimbursement for a charge associated with actual utility consumption 450 for a certain period of time. For example, the charge may be presented to a customer as a bill representing a total monetary amount due to a utility supplier for a particular month. The bill may be presented in electronic (e.g., e-mail, Web page) or paper form with the estimated utility prices 405, the usage terms 410, the predicted load profile 415, the predicted utility margins 420, the predicted incremental costs 425, the allocated utility capacity 445, the actual utility consumption 450, the actual utility margins 455 and/or the actual incremental costs 460 for reference.

Typically, the payment transactions 465 occur on a periodic basis (e.g., monthly). Completing the payment transaction 465 may involve transmitting a charge (e.g., monthly bill) to a customer and receiving an electronic funds transfer from a customer account. In general, the charge (or bill) includes an amount for the utility consumed in accordance with the usage terms 410 plus any applicable incremental costs. Calculating the charge may include summing the costs incurred during certain time periods (e.g., days, hours). The customer, host, utility supplier, and/or third party institution (e.g., bank) may maintain a customer account including funds designated for paying utility charges. When authorized, the customer account may be debited in an amount equal to the charge.

In one implementation, the host posts and releases details of the payment transaction 465 to customers that access the host through the Internet. The host may present the details of the payment transaction 465 to the customer as a UI (e.g., Web page). The UI may include a customer account balance and a history (e.g., statement) of payment transactions 465.

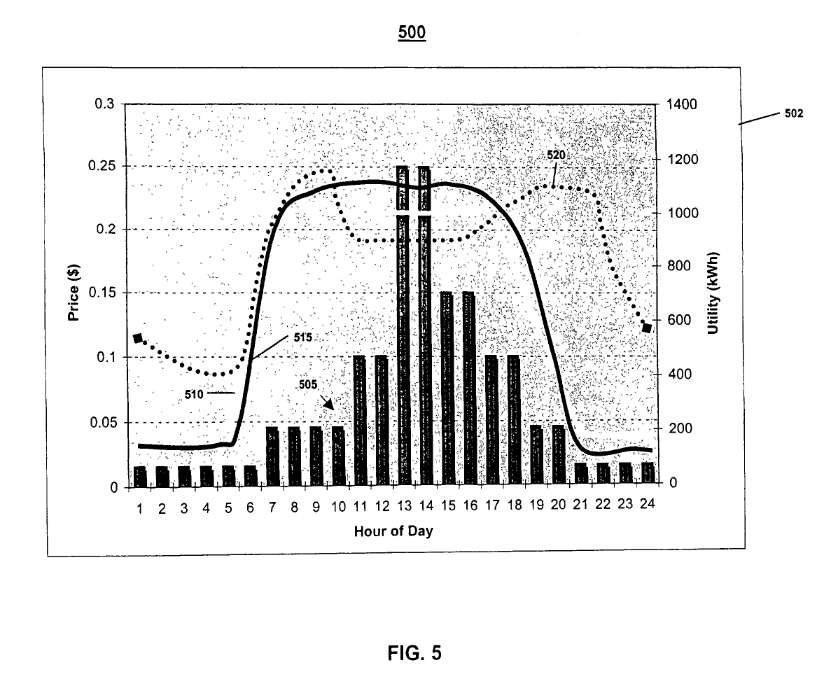

Referring to FIG. 5, a user interface (UI) 500 may be presented by the host to customers and/or utility suppliers. By viewing the UI 500, a customer is able to anticipate demand, forecast utility expenses, and alter future utility consumption. A customer may decide where and for how long to reduce utility consumption to achieve a desired cost savings. A customer having several facilities may take an across-the-board approach to utility management and/or target one or more specific facilities to maximize benefits and minimize inconvenience. In short, a customer can make an informed decision regarding utility consumption.

The UI 500 includes a utility chart 502 that graphically represents estimated utility prices 505, usage terms 510, a predicted load profile 515, and a utility management program 520 for a particular customer. The estimated utility prices 505 are depicted as bar graph points for each hour of a certain day. The usage terms 510 are depicted as a CUB curve indicating the maximum utility consumption for which the estimated utility prices 505 are applicable. The predicted load profile 515 is depicted as a curve indicating the predicted utility consumption for each hour of a certain day. Areas above the usage terms 510 and below the predicted load profile 515 represent predicted utility margins and predicted incremental costs. Areas below the usage terms 510 and above the predicted load profile 515 represent predicted unused capacity and/or potential rebates.

A utility management program 520 is depicted as a curve indicating a proposed load profile. In general, the utility management program 520 is aimed at reducing incremental costs and/or overall costs. The utility management program 520 may involve, for example, shifting areas exceeding the usage terms 510 to time periods having low estimated utility prices 505. The utility management program 520 also may involve reducing utility consumption during time period having high estimated utility prices 505.

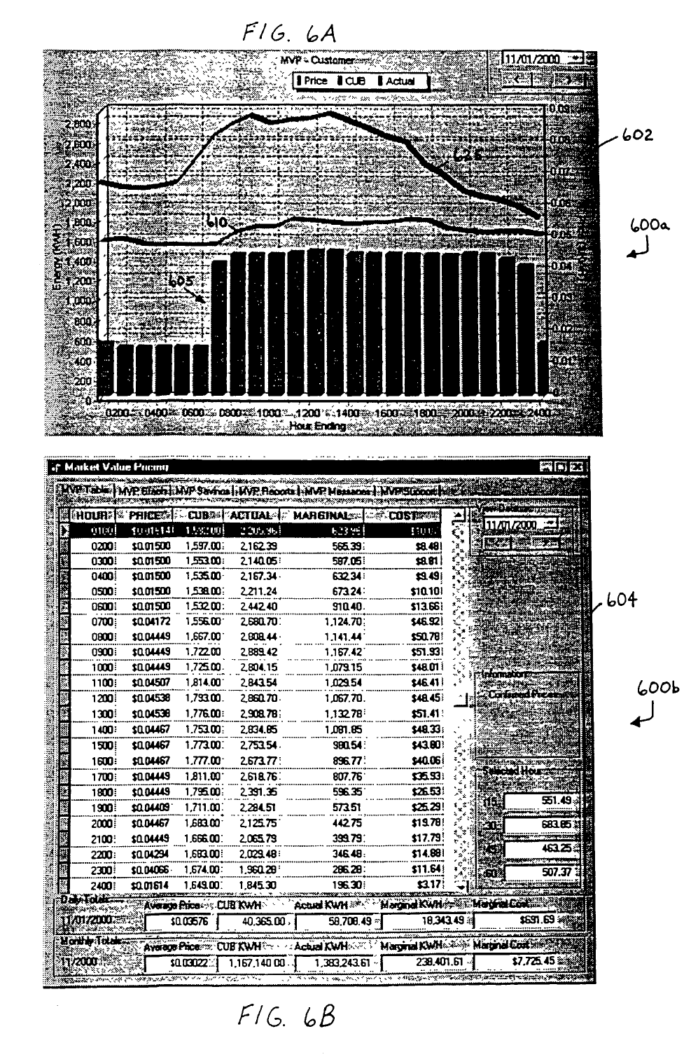

Referring to FIGS. 6A and 6B, a user interface (UI) 600a and/or a UI 600b may be presented by the host to customers and/or utility suppliers. By viewing the UIs 600a and 600b, a customer is able to review actual utility consumption and expenses and alter future utility consumption. A customer may identify activities resulting in utility overuse and plan to avoid such activities in the future. A customer having several facilities may examine consumption and expenses for all facilities or target a specific facility.

The UI 600a includes a utility chart 602 that graphically represents actual utility prices 605, allocated utility capacity 610, and actual utility consumption 625 for a particular customer. The actual utility prices 605 are depicted as bar graph points indicating the standard utility prices for each hour of a certain day. The allocated utility capacity 610 is depicted as a curve indicating the maximum utility capacity for which the actual standard utility prices are applicable. The actual utility consumption 625 is depicted as an actual load profile indicating the amount of utility consumed during each hour of a certain day. Areas above the allocated utility capacity 610 and below the actual utility consumption 625 represent actual utility margins and actual incremental costs. Areas below the allocated utility capacity 610 and above the actual utility consumption 625 represent unused capacity and/or potential rebates.

Referring to FIG. 6B, the UI 600b includes a utility table 604 including the numerical values for the actual utility prices, allocated utility capacity (e.g. CUB), actual utility consumption, actual utility margins, and actual incremental costs for a particular customer. The utility table 604 also may include numerical values for daily and monthly totals and averages. In general, the data included in the utility table 604 is used to create the utility chart 602 and may be exported to other finance programs for analysis. A similar utility table also may be presented in connection with the utility chart 502 of the UI 500 (FIG. 5).

The techniques, methods, and systems described above allow utility suppliers to establish pricing choice programs without encountering insurmountable program development, startup, and management costs. The ability to provide an hourly pricing program to customers provides benefits to the utility and its customers. These benefits include opportunities for significant savings to the customer, customer familiarization with future competitive markets, the utility's ability to establish better relationships with key customers, and opportunities for the utility to increase profitability.

The techniques, methods, and systems described herein may find applicability in any computing or processing environment. Various implementations of the systems and techniques described herein may be realized in digital electronic circuitry, or in computer hardware, firmware, software, or in combinations thereof. A system or other apparatus that uses one or more of the techniques and methods described here may be implemented as a computer-readable storage medium, configured with a computer program, where the storage medium so configured causes a computer system to operate on input and/or generate output in a specific and predefined manner. Such a computer system may include one or more programmable processors that receive data and instructions from, and transmit data and instructions to, a data storage system, and suitable input and output devices. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Generally, a processor will receive instructions and data from a read-only memory and/or a random access memory. Storage devices suitable for tangibly embodying computer instructions and data include all forms of non-volatile memory, including semiconductor memory devices, such as EPROM, EEPROM, and flash memory devices; magnetic disks such as internal hard disks and removable disks; magneto-optical disks; and CD-ROM disks.

These elements also can be found in a desktop or workstation computer as well as other computers suitable for executing computer programs implementing the methods described here, which can be used in conjunction with any content viewing or manipulation software, or any other software capable of displaying portions of a larger body of content. Any of the foregoing may be supplemented by, or implemented in, specially designed ASICs (application specific integrated circuits).

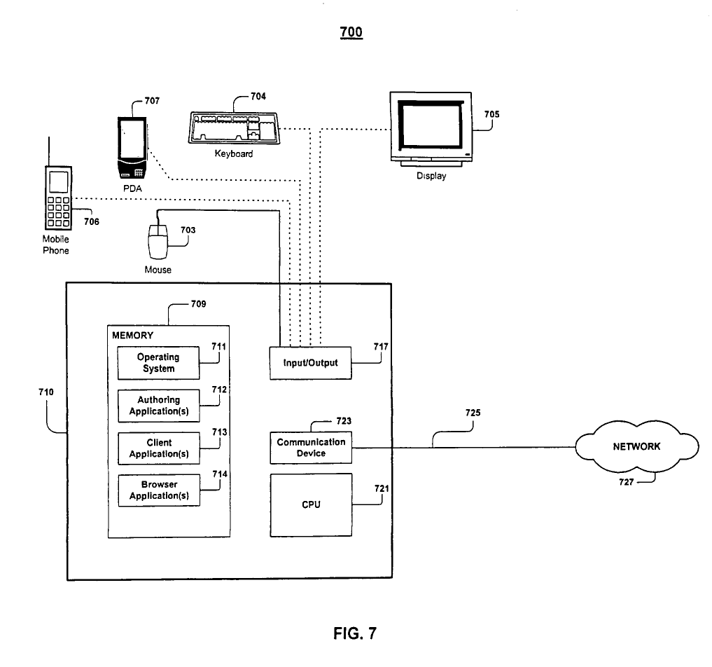

Referring to FIG. 7, a computer system 700 allows a user to perform tasks such as sending, storing, viewing, editing, analyzing, retrieving, and downloading data, including utility consumption data. The computer system 700 of FIG. 7 may also be programmed with computer-readable instructions to enable data to be perceived as stored, viewed, edited, retrieve, downloaded, and otherwise manipulated.

The computer system 700 includes various input/output (I/O) devices (e.g., mouse 703, keyboard 704, display 705, Internet-enabled mobile phone 706, and Internet-enabled PDA 707) and one or more general purpose computers 710 having a central processor unit (CPU) 721, an I/O unit 717 and a memory 709 that stores data and various programs such as an operating system 711, and one or more authoring applications 712 (e.g., programs for word processing, creating spread sheets, and producing graphics), one or more client applications 713 (e.g., programs for accessing online services), and one or more browser applications 714 (e.g., programs for retrieving and viewing electronic documents from the Internet and/or Web). The computer system 700 also includes a communications device 723 (e.g., a satellite receiver, a modem, or network adapter) for exchanging data with a host (not shown) through a communications link 725 (e.g., a telephone line and/or a wireless link) and/or a network 727.

A number of implementations have been described. Nevertheless, it will be understood that various modifications may be made. For example, the Internet-enabled mobile phone 706 and/or Internet-enabled PDA 707 may each include some or all of the components of the general purpose computer 710 and may be used to access a host through the communications link 725 and/or the network 727.

Accordingly, other implementations are within the scope of the following claims. Changes may be made in the combinations, operations, and arrangements of the various parts and elements described herein without departing from the spirit and scope of the invention.

What is claimed is:

1. An Internet-based utility management method comprising:
presenting estimated utility prices and usage terms to a customer, the estimated utility prices including predicted prices of a utility during certain future periods of time, the usage terms including a utility usage threshold for each certain future period of time below which the estimated utility price applies; and
presenting a predicted load profile to a customer, the predicted load profile including predicted utility usage of the customer for each certain future period of time and being presented such that any variation between the usage terms and the predicted load profile is readily apparent.

2. The utility method of claim 1 wherein the estimated utility prices include the predicted spot prices of a utility for each hour of an upcoming day.

3. The utility management method of claim 1 wherein presenting the usage terms includes determining and displaying a customer usage baseline illustrating the threshold limits below which standard estimated prices apply.

4. The utility management method of claim 3 wherein determining the customer usage baseline includes analyzing historical use data.

5. The utility management method of claim 3 wherein the customer usage baseline is tailored to the expected utility usage of the customer.

6. The utility management method of claim 1 wherein presenting the predicted load profile includes analyzing one or more previous actual load profiles of the customer.

7. The utility management method of claim 1 further comprising presenting predicted utility margins, the predicted utility margins including the deviation of the predicted load profile from the usage terms for a certain time period.

8. The utility management method of claim 1 further comprising presenting predicted incremental costs, the predicted incremental costs including costs associated with the deviation of the predicted load profile from the usage terms for a certain time period.

9. The utility management method of claim 1 further comprising evaluating future utility consumption.

10. The utility management method of claim 9 wherein evaluating future utility consumption includes confirming that future utility consumption is consistent with the presented predicted load profile.

11. The utility management method of claim 1 further comprising determining a utility management program, the utility management program including actions for reducing energy consumption.

12. The utility management method of claim 11 wherein the utility management program is tailored to at least one of facilities, equipment, and requirements of the customer.

13. The utility management method of claim 11 wherein the utility management program includes offloading certain equipment during peak hours.

14. The utility management method of claim 11 wherein the utility management program includes sufficiently reducing utility consumption by a certain amount so as to comply with the usage terms or to achieve a reduced peak demand level.

15. The utility management method of claim 11 wherein the utility management program includes user preferences for customizing the actions to minimize at least one of total down time, down time during normal business hours, total number of idle devices, number of idle devices during normal business hours, and customer inconvenience.

16. The utility management method of claim 11 wherein determining a utility management program includes selecting one of several proposed utility management programs or selecting elements from one or more proposed utility management programs.

17. The utility management method of claim 11 wherein the utility management is assigned a particular level based on severity of the action required to reduce consumption.

18. The utility management method of claim 1 further comprising reaching an agreement as to utility price and usage terms.

19. The utility management method of claim 18 wherein the agreement includes purchasing a utility in compliance with the usage terms at a standard utility price and purchasing a utility in violation of the usage terms at a penalized utility price.

20. The utility management method of claim 18 wherein reaching the agreement comprises locking in the presented utility prices and usage terms for an upcoming day.

21. The utility management method of claim 1 further comprising negotiating lower standard prices in exchange for stricter usage terms and higher penalties for violating the usage terms.

22. The utility management method of claim 1 further comprising negotiating a rebate for unutilized capacity.

23. The utility management method of claim 1 further comprising presenting allocated utility capacity, the allocated utility capacity including permitted utility consumption during a certain period of time.

24. The utility management method of claim 1 further comprising presenting actual utility consumption.

25. The utility management method of claim 24 wherein presenting the actual utility consumption includes displaying an actual load profile representing the actual amount of utility consumed during certain period of time.

26. The utility management method of claim 1 further comprising presenting actual utility margins, the actual utility margins including deviation of the actual utility consumption from the allocated utility consumption for certain periods of time.

27. The utility management method of claim 1 further comprising presenting actual incremental costs, the actual incremental costs including costs associated with the deviation of the actual utility consumption from the allocated utility capacity for certain time periods.

28. The utility management method of claim 27 wherein presenting the actual incremental costs includes associating a monetary value with the actual utility margins.

29. The utility management method of claim 1 further comprising completing a payment transaction, the payment transaction including a reimbursement for a charge associated with utility consumption for a certain period of time.

30. The utility management method of claim 1 further comprising displaying a user interface having at least one of charts, figures, graphs, text, images, audio, and video.

31. The utility management method of claim 1 further comprising analyzing at least one of pricing data, cost data, weather data, and usage data.

32. The utility management method of claim 1 further comprising delivering data by at least one of e-mail, facsimile, telephone, satellite transmission, the Web and/or the Internet.

33. A computer program for transferring electronic data between users of a communications system, the computer program being stored on a computer readable medium and comprising instructions for:
presenting estimated utility prices and usage terms to a customer, the estimated utility prices including predicted prices of a utility during certain future periods of time, the usage terms including a utility usage threshold for each certain future period of time below which the estimated utility price applies; and
presenting a predicted load profile to a customer, the predicted load profile including predicted utility usage of the customer for each certain future period of time and presented such that any variation between the usage terms and the predicted load profile is readily apparent.

34. The computer program of claim 33, the computer readable medium comprising a disk.

35. The computer program of claim 33, the computer readable medium comprising a client device.

36. The computer program of claim 33, the computer readable medium comprising a host device.

37. The computer program of claim 33, the computer readable medium comprising a propagated signal.

38. A communications apparatus for transferring electronic data between users of a communications system, the apparatus configured to:
present estimated utility prices and usage terms to a customer, the estimated utility prices including predicted prices of a utility during certain future periods of time, the usage terms including a utility usage threshold for each certain future period of time below which the estimated price applies; and
present a predicted load profile to a customer, the predicted load profile including predicted utility usage of the customer for each certain future period of time and presented such that any variation between the usage terms and the predicted load profile is readily apparent.

39. The communications apparatus of claim 38, wherein the apparatus comprises a host device.

40. The communications apparatus of claim 38, wherein the apparatus comprises a client device.
